(19) United States
(12) Patent Application Publication
(10) Pub. No.: US 2018/0131242 A1
(43) Pub. Date: May 10, 2018

(54) INDUCTIVE POWER TRANSMITTER, RECEIVER AND METHOD OF OPERATION

(71) Applicant: PowerbyProxi Limited, Auckland (NZ)

(72) Inventor: Jeffrey Douglas Louis, Auckland (NZ)

(21) Appl. No.: 15/804,873

(22) Filed: Nov. 6, 2017

Related U.S. Application Data
(60) Provisional application No. 62/417,579, filed on Nov. 4, 2016.

(51) Int. Cl. H02J 50/80; H02J 50/12; H04B 5/00

(52) U.S. Cl. CPC H02J 50/80; H02J 50/12; H02J 7/025; H04B 5/0075; H04B 5/0031; H04B 5/0037

(57) ABSTRACT

A method of communication of information as to receiver coil type to an inductive power transmitter to enable different modes of operation of inductive power transmitters and/or inductive power transmitters utilizing such information. An inductive power receiver may include a communications circuit for communicating with an inductive power transmitter to transmit information as to the receiver coil type. Transmitter coils of an inductive power transmitter may be driven in a first mode and also in a second mode if it receives receiver coil type information associated with the second mode. The power transmitter may include a controller configured to receive receiver coil type information from an inductive power receiver and to drive a plurality of power transmitting coils in one of a plurality of modes depending on the receiver coil type.

This patent application claims the benefit of provisional patent application 62/417,579, filed on Nov. 4, 2016, which is hereby incorporated by reference herein in its entirety.

### FIELD

The present invention relates to the communication of information as to receiver coil type to an inductive power transmitter and to modes of operation of inductive power transmitters and/or inductive power receivers utilizing such information.

### BACKGROUND

Electrical converters are found in many different types of electrical systems. Generally speaking, a converter converts a supply of a first type to an output of a second type. Such conversion can include DC-DC, AC-AC and DC-AC electrical conversions. In some configurations a converter may have any number of DC and AC ‘parts’, for example a DC-DC converter might incorporate an AC-AC converter stage in the form of a transformer.

The term ‘inverter’ may sometimes be used to describe a DC-AC converter specifically. Again, such inverters may include other conversion stages, or an inverter may be a stage in the context of a more general converter. Therefore, the term inverter should be interpreted to encompass DC-AC converters, either in isolation or in the context of a more general converter. For the sake of clarity, the remainder of this specification will refer to the DC-AC converter of the invention by the term ‘inverter’ without excluding the possibility that the term ‘converter’ might be a suitable alternative in some situations.

One example of the use of inverters is in inductive power transfer (IPT) systems. IPT systems will typically include an inductive power transmitter and an inductive power receiver. The inductive power transmitter includes a transmitting coil or coils, which are driven by a suitable transmitting circuit to generate an alternating magnetic field. The alternating magnetic field will induce a current in a receiving coil or coils of the inductive power receiver. The received power may then be used to charge a battery, or power a device or some other load associated with the inductive power receiver. Further, the transmitting coil and/or the receiving coil may be connected to a resonant capacitor to create a resonant circuit. A resonant circuit may increase power throughput and efficiency at the corresponding resonant frequency.

So-called double D or “DD” coils driven in anti-phase or opposite polarity are known to generate a magnetic field having enhanced flux density at greater height above the coils (improved z) compared to such coils driven in phase. Such DD coils are disclosed in WO2013036146 to Auckland Uniservices Limited, the disclosure of which is incorporated by reference. So called DD quadrature coils or “DDQ” coils consist of a pair of DD coils with a further coil positioned across the DD coils. DD coils may be used advantageously as transmitter coils with DDQ coils used as receiver coils in applications such as electric vehicle charging where good coupling over large coil separation is desirable.

It would be desirable to utilize the improved z provided by DD coils driven in antiphase in other applications. DD coils also reduce the amount of flux available for stray coupling to foreign objects (that are beside, but not under the receiver), reducing the likelihood of charging being disabled due to foreign object detection. However, in many other charging applications, especially for consumer electronics, it may be necessary for an inductive power transmitter to be capable of efficiently transferring power to a range of devices having different types of receiver coils and modes of operation.

Such inductive power transmitters for consumer electronic applications must typically be capable of efficiently transferring power to simple circular or “C” coils. When DD transmitter coils driven in anti-phase are employed with conventional C coils the magnetic coupling may exhibit a significant reduction in certain areas such as the centre of the DD transmitter coils and referred to as a dead spot (or “null”), which may reduce power transfer to an unacceptable level.

It has therefore not been possible to date to exploit the improved z provided by DD coils driven in antiphase for inductive power transmitters that must be compatible with a broad range of receiver coil types.

### SUMMARY

According to one exemplary embodiment there is provided a method of power transfer between an inductive power transmitter and an inductive power receiver, comprising:
a. driving a plurality of transmitter coils of the inductive power transmitter in a first mode;
b. receiving a signal from the inductive power receiver including information indicating receiver coil type for the inductive power receiver; and
c. driving the plurality of transmitter coils in a second mode if the receiver coil type is associated with the second mode.

According to another exemplary embodiment there is provided an inductive power transmitter, comprising:
a. a plurality of power transmitter coils;
b. a controller configured to receive a communications signal including information as to receiver coil type from an inductive power receiver, and to drive the plurality of power transmitting coils in one of a plurality of modes depending on the receiver coil type.

According to another exemplary embodiment there is provided an inductive power transmitter, comprising:
a. a power transmitting coil;
b. a controller configured to receive communications signal from an inductive power receiver including information as to a power receiver coil type in order to control operation of the power transmitting coil.

According to another exemplary embodiment there is provided an inductive power transmitter, comprising:
a. a pair of transmitter coils in a DD coil configuration;
b. a controller configured to receive a communications signal from an inductive power receiver including information as to a power receiver coil type and drive the transmitter coils in phase or in anti-phase in dependence upon the information as to coil type.

According to another exemplary embodiment there is provided an inductive power transmitter, comprising:
a. a power transmitting coil; and
b. a controller which drives the power transmitting coil and is configured to change its mode of driving the transmitter coil in dependence upon receiver coil type.

According to another exemplary embodiment there is provided an inductive power receiver, comprising:
a. one or more power receiving coils;
b. a communications circuit for communicating with an inductive power transmitter, wherein the communications circuit is adapted to transmit information as to the receiver coil type.

According to another exemplary embodiment there is provided an inductive power transfer system including:
a. an inductive power transmitter, comprising:
   i. a power transmitting coil;
   ii. a transmitter controller which drives the power transmitting coil in a plurality of modes; and
   iii. a transmitter communications circuit for communicating with an inductive power receiver; and
b. an inductive power receiver, comprising:
   i. a power receiving coil;
   ii. a receiver controller which operates the power receiving coil in a plurality of modes; and
   iii. a receiver communications circuit for communicating with the transmitter communications circuit,
   wherein the transmitter controller and receiver controller communicate negotiate the modes of operation of the transmitter controller and receiver controller via the communications circuits.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components which the use directly references, and possibly also of other non-specified components or elements.

Reference to any prior art in this specification does not constitute an admission that such prior art forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 is a general representation of an inductive power transfer system;

FIG. 2 is a schematic of a C type coil;

FIG. 3 is a schematic of a DD type coil;

FIG. 4 is a schematic of a DDQ type coil;

FIG. 5 is a schematic of an inductive power transfer system with DD type transmitter coils and a C type receiver coil;

FIG. 6 is a schematic of an inductive power transfer system with DD type transmitter coils and a DDQ type receiver coil;

FIG. 7 is a circuit diagram for switching the polarity of drive signals applied to a transmitter coil;

FIG. 8 is a circuit diagram for switching the polarity of drive signals applied to a pair of transmitter coils using a bridge when driving the coils in phase;

FIG. 9 is a circuit diagram for switching the polarity of drive signals applied to a pair of transmitter coils using a bridge when driving the coils in anti-phase;

FIG. 10 is a schematic of an exemplary configuration packet structure; and

FIGS. 11-12 is a flow diagram illustrating the steps of operation of an inductive power transfer system.

### DETAILED DESCRIPTION

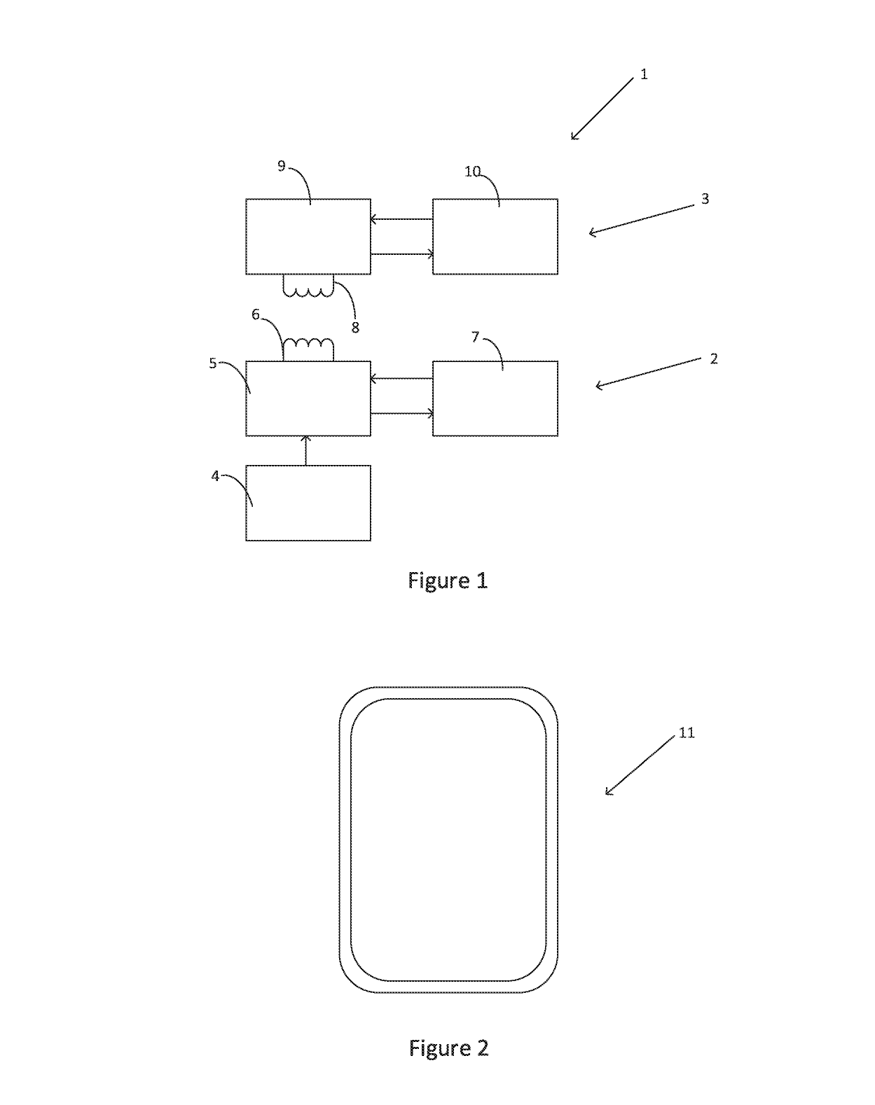

FIG. 1 shows a representation of an inductive power transfer (IPT) system 1. The IPT system includes an inductive power transmitter 2 and an inductive power receiver 3. The inductive power transmitter is connected to an appropriate power supply 4 (such as mains power). The inductive power transmitter may include a coil drive circuit 5 which typically includes an AC-DC converter that is connected to an inverter. The inverter supplies a transmitting coil or coils 6 with an AC current so that the transmitting coil or coils generate an alternating magnetic field. In some configurations, the transmitting coils may also be considered to be separate from the inverter. The transmitting coil or coils may be connected to capacitors (not shown) either in parallel or series to create a resonant circuit.

FIG. 1 also shows a controller 7 within the inductive power transmitter 2. The controller may be connected to each part of the inductive power transmitter. The controller may be adapted to receive inputs from each part of the inductive power transmitter and produce outputs that control the operation of each part. Those skilled in the art will appreciate that the controller may be implemented as a single unit or separate units. Those skilled in the art will appreciate that the controller may be adapted to control various aspects of the inductive power transmitter depending on its capabilities, including for example: power flow, tuning, selectively energising transmitting coils, inductive power receiver detection and/or communications.

The inductive power receiver 3 includes a receiving coil or coils 8 that is connected to power receiving circuitry 9 that in turn supplies power to a load. When the inductive power transmitter 2 and inductive power receiver 3 are suitably coupled, the alternating magnetic field generated by the transmitting coil or coils 6 induces an alternating current in the receiving coil or coils 8. The receiving circuitry is adapted to convert the induced current into a form that is appropriate for the load. The receiving coil or coils may be connected to capacitors (not shown) either in parallel or series to create a resonant circuit. The receiver may include a controller 10 which may, for example, include a communications circuit and control the tuning of the receiving coil or coils, or the power supplied to the load by the receiving circuitry.

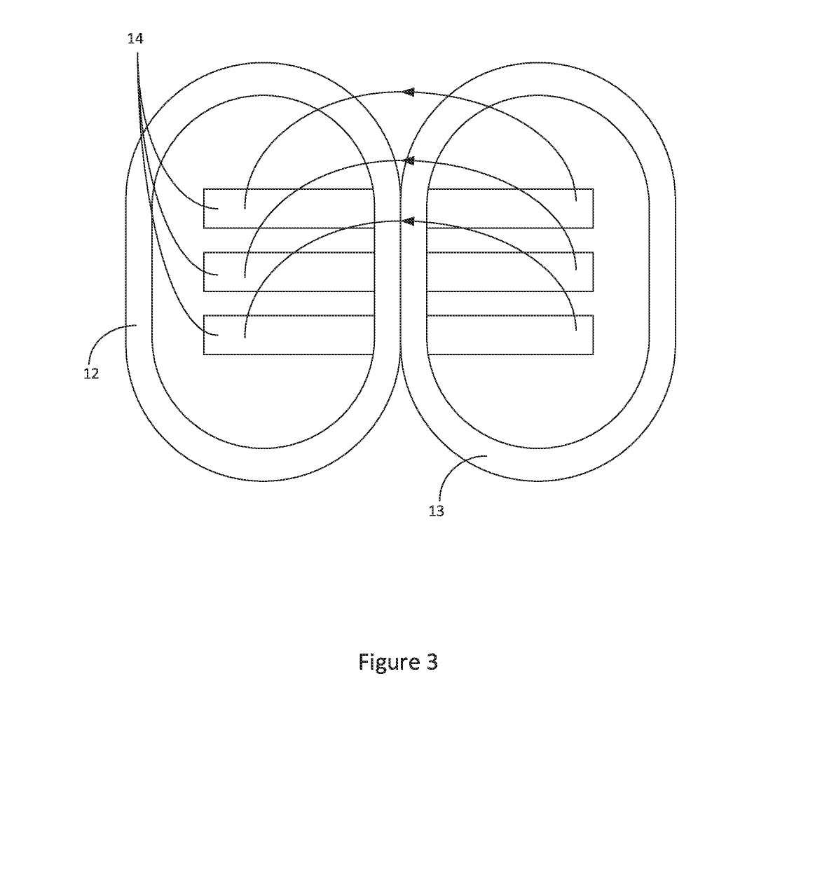

FIG. 2 shows a conventional “C” type coil consisting of a plurality of windings typically formed by winding wire into a coil form or by printing on to a printed circuit board.

FIG. 3 shows a DD type coil consisting of two adjacent coils 12 and 13 with magnetically permeable cores 14 providing a flux path under the coils between coil centres. The flux lines illustrate the flux path when the coils 12 and 13 are driven in anti-phase or substantially opposite polarity. Anti-phase may be achieved when two fields are “substantially” 180° different in phase even if they are not perfectly 180° offset. In this case substantially opposite polarity may mean, for example, a phase difference of 180°, ±1%, +5% or +10%.

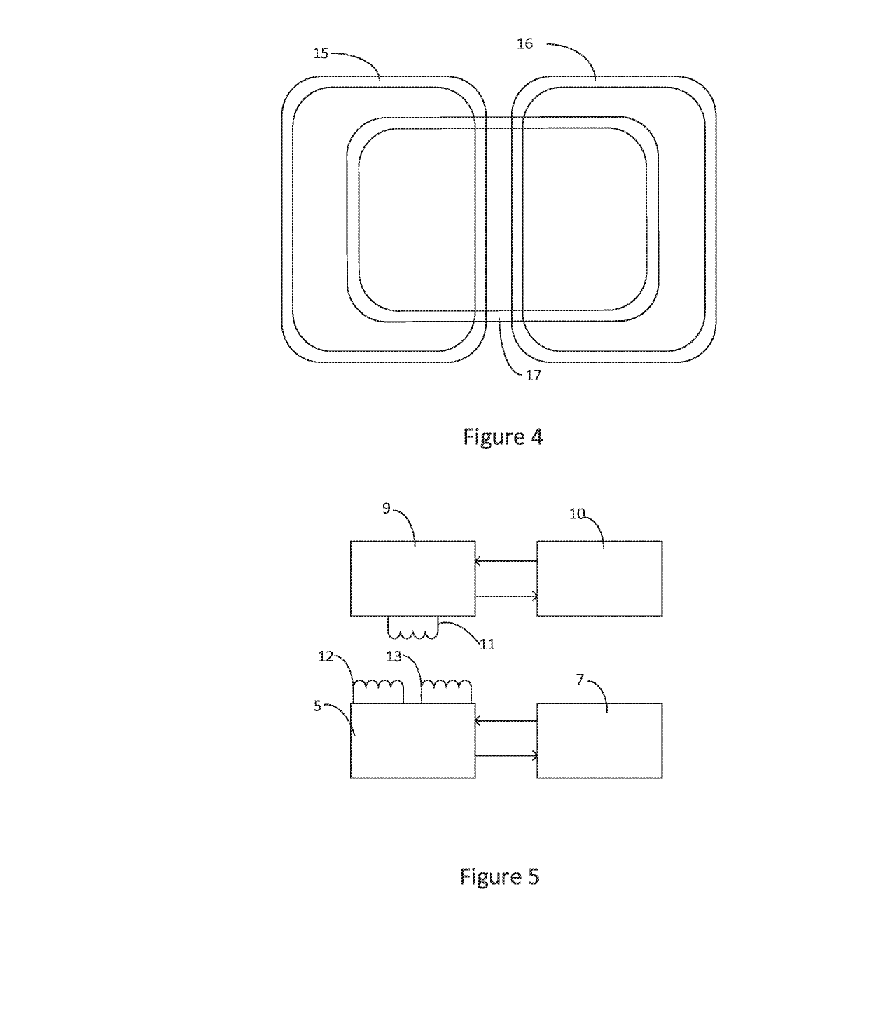

FIG. 4 shows a DDQ type coil consisting of two adjacent coils 15 and 16 and a “quadrature coil” 17 overlapping coils 15 and 16. DDQ type coils are particularly suited as receiver coils for use with DD type transmitter coils to achieve effective power transfer for large transmitter coil and receiver coil separation.

FIG. 5 shows an inductive power transfer system in which the transmitter drives DD coils 12 and 13 and the receiver pickup coil 11 is a C type coil. The remainder of the system is as per FIG. 1 and like numerals indicate like integers.

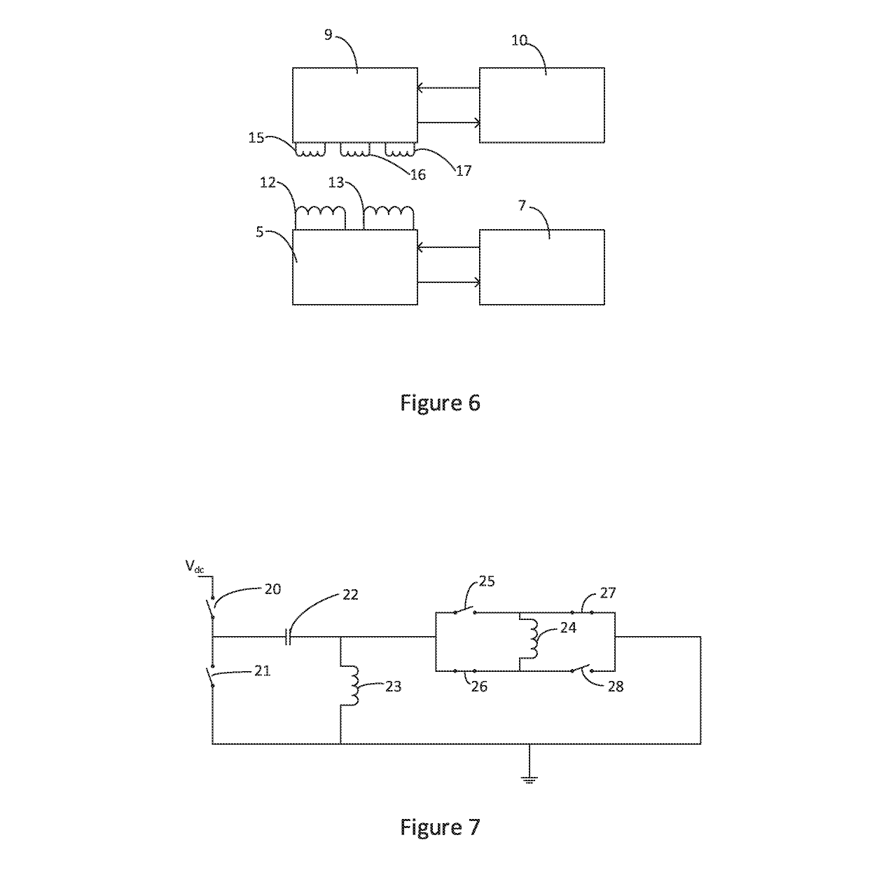

FIG. 6 shows an inductive power transfer system in which the inductive power transmitter driving DD coils 12 and 13 with the inductive power receiver employing a DDQ type pick up coil consisting of coils 15, 16 and 17.

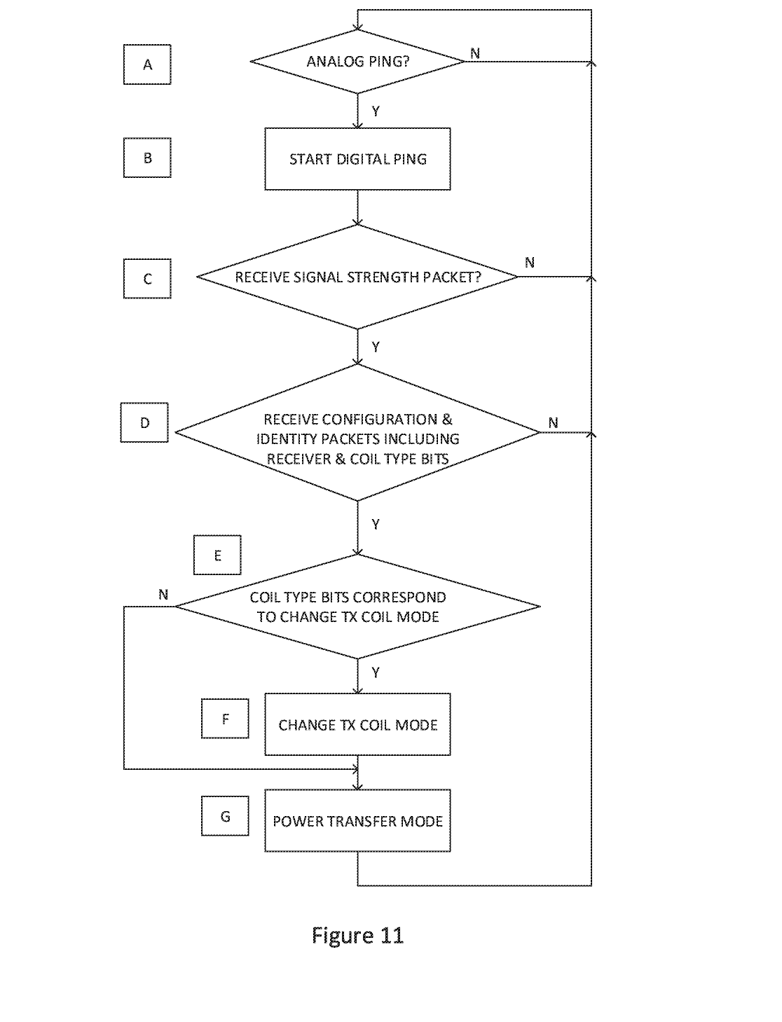

The operation of the inductive power transmitter shown in FIGS. 5 and 6 employing a DD type coil will be discussed in relation to the flow diagram of FIG. 11 for both the situation where the inductive power receiver employs a C type coil (FIG. 5) and a DDQ type coil (FIG. 6).

Before energising coils 12 and 13 to supply power the inductive power transmitter needs to detect that an inductive power receiver is present (Step A in FIG. 11 commonly referred to as “Analog Ping”). The inductive power transmitter may detect the presence of an inductive power receiver in a variety of ways including providing a periodic burst of power to coils 12 and 13 and detecting modulation due to the presence of an inductive power receiver, detection using a specific detection coil, impact sensor, light sensor, proximity sensor etc.

Upon detecting the presence of an inductive power receiver (Digital Ping step B in FIG. 11) controller 7 energises coils 12 and 13 in a first mode (mode 1). The mode may control coil selection, the coil topology employed, the polarity of drive signals applied, the power level supplied to each coil or some other attribute. In the present example in mode 1 both DD coils 12 and 13 are driven in phase. By starting in mode 1 this ensures that both the C receiver coil type and the DDQ receiver coil type receive sufficient power to power up and transmit receiver coil type information to the inductive power receiver.

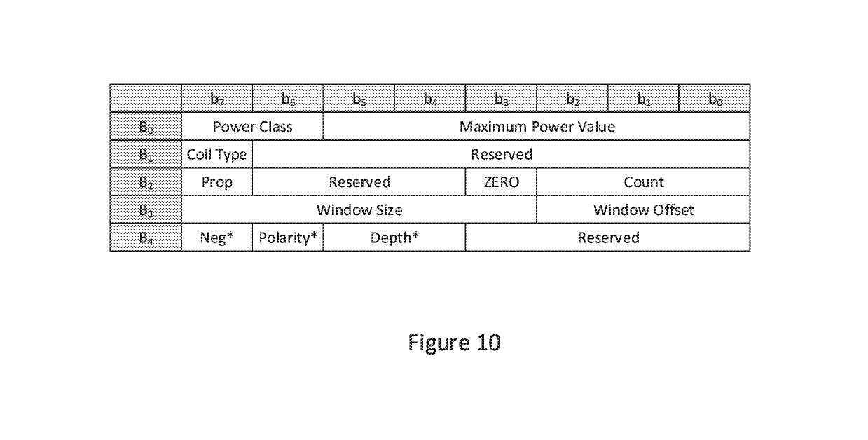

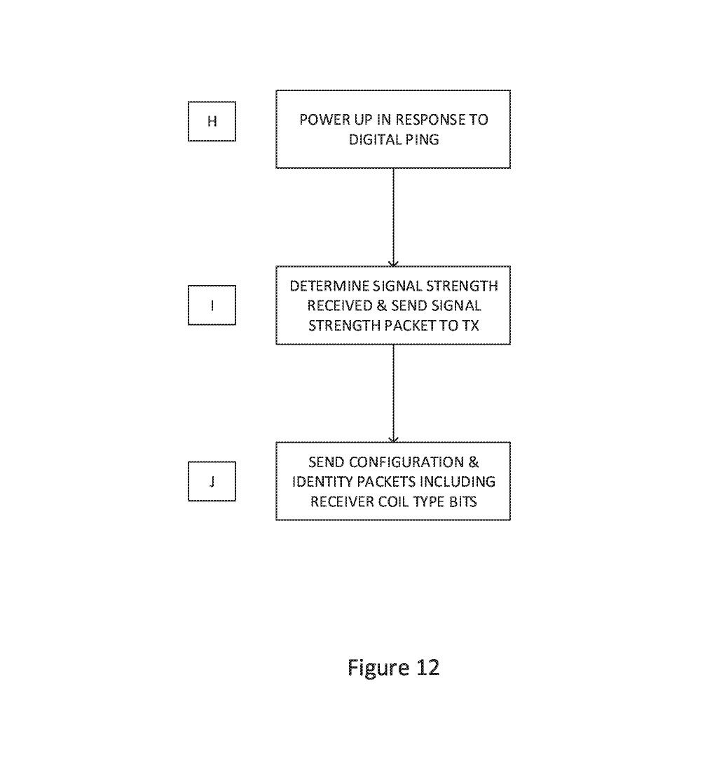

Commonly the receiver controller powers up in response to the Digital Ping (Step H in FIG. 12) and determines the signal strength and includes a communication circuit to send signal strength information, configuration information and device identity information to a communication circuit of receiver controller 7 (Steps I and then J in FIG. 12). Such information may be sent in a configuration packet where specific bits are assigned specific meaning under a protocol such as the Qi protocol. In this example information as to the receiver coil type may also be transmitted—either within a configuration packet or in a separate communication. The coil type information could be one bit, a number of bits or one or more flags. For the example, where only a DD type transmitter coil is to be employed, the receiver coil type information could be a single bit indicating whether the receiver coil is of a type compatible with the DD transmitter coils being driven in anti-phase. FIG. 10 is an exemplary configuration packet in which the receiver coil type information is a single bit at location B₁ b₇. Where a greater range of transmitter coil types are available more bits may be required to identify all coil types. The coil type information may also be broken up into a number of attributes such as coil number, coil topology, coil modes of operation etc. In this case further bits may be added in row B₁.

Often communication is unidirectional from the power receiver to the power transmitter via backscatter modulation. In backscatter modulation, the power-receiver coil is loaded, changing the current draw at the power transmitter. These current changes are monitored and demodulated into the information required for the two devices to work together. However, communication may be bidirectional where the inductive power transmitter is able to modulate drive signals supplied to transmitter coils or where an independent radio or optical communications channel is provided.

The transmitter controller monitors the backscatter communications channel with the receiver for information as to signal strength (Step C in FIG. 11). This may be followed by a configuration packet with other information such as configuration information, device identity and transmitter coil type (Step D in FIG. 11). Alternatively coil type information may be sent in another packet or in some other way.

In response to the transmitter controller 7 receiving receiver coil type information the transmitter controller 7 determines whether the transmitter coils can be optimised for the specified receiver coil type (Step E in FIG. 11). In the present example, if the transmitter is driving DD type coils and the receiver is using DDQ type coils (FIG. 6) then the mode of operation may advantageously be set to a second mode, mode 2 in which the DD coils 12 and 13 are driven in anti-phase (Step F in FIG. 11). If the transmitter is driving DD type coils and the receiver is using C type coils (FIG. 5), then the mode of operation may remain in mode 1 with the DD coils being driven in phase. Power transfer then continues in Step G.

In the above example a single bit may allow operation to toggle between two modes base on a single receiver coil type bit. For large numbers of receiver coil types a look-up table may be provided for controller 7 to determine the optimal transmitter coil operation for a specified receiver coil type. This may include determination of which transmitter coils to drive, the circuit topology to be employed, drive power levels, mode of operation (e.g. in phase or anti-phase) etc.

Where both the transmitter and receiver can control the modes of operation of their transmitter coils and receiver coils, and bidirectional communication is available, both transmitter coil and receiver coil operation may be optimised through negotiation between the transmitter controller 7 and receiver controller 10. This may involve communication of each side's possible modes of operation and configuration of each side according to the optimal pairing of devices.

Referring now to FIG. 7, a circuit to change the transmitter drive circuit topology for mode 1 and mode 2 operation is shown. A half bridge formed by switches 20 and 21 supplies a high frequency AC drive signal via capacitor 22 to DD coils 23 and 24 (corresponding to coils 12 and 13 in FIGS. 5 and 6). Transmitter coil 23 is always driven with the same polarity. The switch network 25 to 28 enables transmitter coil 24 to be connected to the high frequency AC drive signal with either polarity. When switches 26 and 27 closed and switches 25 and 28 open as shown in FIG. 7 transmitter coil 24 may be driven in anti-phase to transmitter coil 23 (i.e. mode 2). When switches 25 and 28 are closed and switches 26 and 27 are open transmitter coil 24 may be driven in phase with transmitter coil 23 (i.e. mode 1). These switches 25 to 28 are “slow” switches (i.e. not switch mode) and only act to change the direction of the current from the half bridge through the second coil and so relatively inexpensive switches may be employed.

This arrangement may be modified by placing transmitter coil 23 in series with transmitter coil 24 (i.e. between capacitor 22 and switches 25 and 26) In this configuration the current in each transmitter coil is forced to be identical, whereas in the parallel topology this may have imbalanced operation and reduced performance. This arrangement requires only relatively slow switches and only simple logic is required to configure the switches depending upon the mode, with excitation from the inverter remaining the same as for existing approaches.

Driving the DD coils in anti-phase or reverse polarity may be implemented by various approaches depending on the requirements of the application. For example, a first coil may be wound in the reverse direction to that of an adjacent second coil winding, where both coils are formed from one and the same coil winding conductors, producing two coils connected electrically in series. Alternatively a first coil may be connected to an AC energy source (e.g. inverter, oscillator or power amplifier) with reverse polarity compared to the polarity of a similar, adjacent second coil. In a further alternative a first coil and an adjacent second coil may be connected to separate AC energy sources, and where the A.C. energy sources are configured electrically (e.g. energy source timing signals co-ordinated to be 180 degrees out of phase), or mechanically (e.g. relay) to drive the current in the second coil with a phase difference of 180 degrees (or substantially this value). In a still further alternative a first coil and an adjacent second coil may be connected through a commutation or switching circuit to a single or multiple AC or DC energy sources that produces a current in the first coil that has a phase substantially 180 degrees compared to the current in the second coil.

In any of the examples given above anti-phase, meaning a 180° or substantially 180° offset, includes can account for manufacturing tolerances. In embodiments where anti-phase (e.g., 180° phase difference or substantially 180° phase difference) is achieved by winding two coils in reverse relative to each other and driving both coils with the same signal, a person of ordinary skill in the art will appreciate that the two coils are generate phase and anti-phase signals even if the physical winding, due to manufacturing, are not perfectly mirror images. In embodiments where anti-phase is achieved by driving two coils of the same design using AC signals that are 180° phase shifted, a person of ordinary skill in the art would appreciate that component manufacturing tolerances may mean that the phase shift is only approximately 180° and may vary by an amount depending on the requirements of the application. Also, substantially 180° is intended to cover scenarios in which the coils are intentionally driven with a offset from 180° (e.g., 179.9°) to substantially achieve one or more benefits of anti-phase without using exactly 180°.

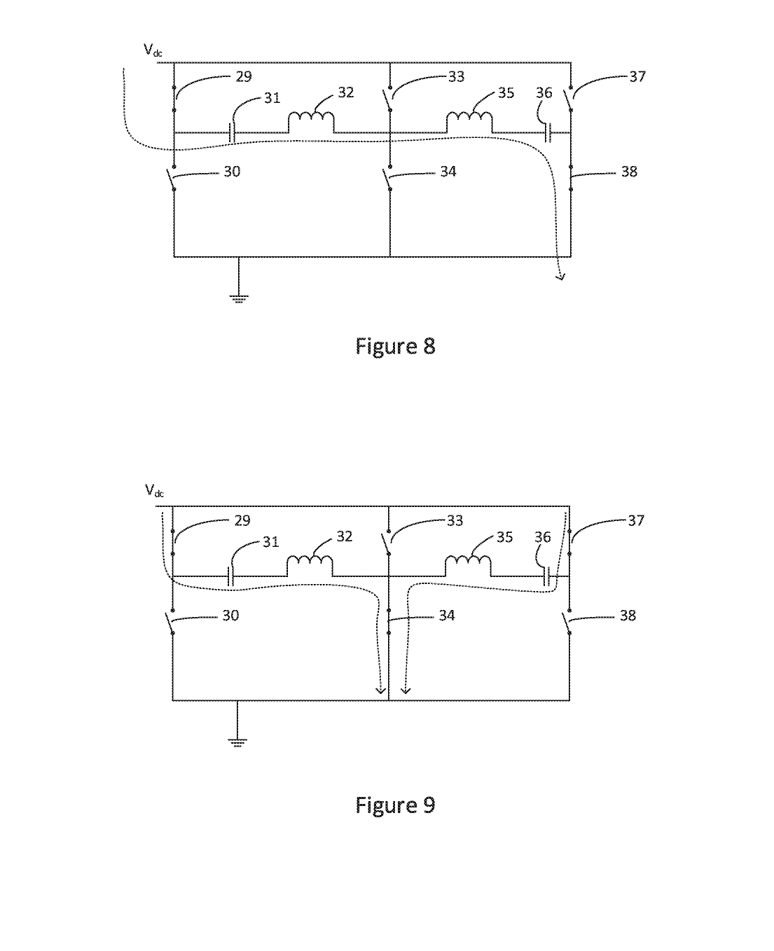

Referring now to FIGS. 8 and 9 an alternate circuit to change the transmitter drive circuit topology for mode 1 and mode 2 operation is shown. In this circuit the operation of a full bridge consisting of six high speed switches 29, 30, 33, 34, 37 and 38 is controlled to effect mode 1 and mode 2 operation.

In a first mode (FIG. 8) switches 29 and 38 are on with all other switches off for a first half cycle so that current flows from Vdc through switch 29, capacitor 31, transmitter coil 32, transmitter coil 35, capacitor 36 and switch 38. In the second half cycle switches 30 and 37 are on and the other switches off to reverse current flow through the transmitter coils.

In a second mode (FIG. 9) switches 29, 34 and 37 are on with all other switches off for a first half cycle so that current flows from Vs through switches 29 and 37, through each transmitter coil and commonly through switch 34 as indicated in dashed line. In the second half cycle switches 30, 33 and 38 are on and the other switches off to reverse current flow through the transmitter coils. This arrangement provides full-bridge equivalent operation, therefore double the effective excitation voltage is applied across the transmitter coils for the same system DC input supply as compared to the half-bridge shown in FIG. 7. This gives a higher power capability for the same DC input voltage. Further as a full-bridge it makes expensive and bulky high voltage, high current series capacitors unnecessary—unless they are also desired for resonant operation. It does, however, require six high speed switches and more complex logic to drive and co-ordinate the switches and ensure safe switching.

Whilst the above example describes operation for an inductive power transmitter employing a DD type coil for operation with either a C type or a DDQ type receiver coil it will be appreciated that this concept is applicable to a wide range of transmitter and receiver coil types. Transmitters and/or receivers may be able to select the coils to be used, drive power levels, mode of operation (e.g. in phase or anti-phase) etc. Whilst such information may be associated with a coil type in a look up table coil type information may also be broken up into a number of attributes such as coil number, coil topology, coil modes of operation etc. and it will be appreciated that the concept is not limited to any specific coil types or modes of operation

There is thus provided enhanced interoperability and optimisation of power transfer for a wide range of coil topologies and modes of operation. This may allow improved power transfer at greater coil separation for compatible coil types whilst maintaining performance for incompatible coil types. This may also reduce foreign object detection issues due to more confined flux patterns where available.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. A method of power transfer between an inductive power transmitter and an inductive power receiver, comprising:
a. driving a plurality of transmitter coils of the inductive power transmitter in a first mode;
b. receiving a signal from the inductive power receiver including information indicating receiver coil type for the inductive power receiver; and
c. driving the plurality of transmitter coils in a second mode if the receiver coil type is associated with the second mode.

2. A method as claimed in claim 1 wherein in the first mode all transmitter coils are driven in phase and in the second mode one or more transmitter coils are driven in phase and one or more transmitter coils are driven in anti-phase.

3. A method as claimed in claim 1 or claim 2 wherein the receiver coil type information is communicated using backscatter communication between the inductive power receiver and the inductive power transmitter.

4. A method as claimed in any one of claims 1 to 3 wherein the receiver coil type information is communicated as one or more bit of a configuration packet.

5. A method as claimed in claim 4 wherein the receiver coil type information is a single bit which controls whether the inductive power transmitter drives the transmitter coils in the first mode or the second mode.

6. A method as claimed in any one of claims 1 to 5 wherein the mode governs both the selection of the transmitter coils driven and whether each driven coil is driven in phase or anti-phase.

7. A method as claimed in any one of the preceding claims wherein the coil type is a C coil or a DDQ coil.

8. An inductive power transmitter, comprising:
a. a plurality of power transmitter coils;
b. a controller configured to receive a communications signal including information as to receiver coil type from an inductive power receiver, and to drive the plurality of power transmitting coils in one of a plurality of modes depending on the receiver coil type.

9. An inductive power transmitter as claimed in claim 8 having a first mode in which all transmitter coils are driven in phase and a second mode in which one or more transmitter coils are driven in phase and one or more transmitter coils are driven in anti-phase.

10. An inductive power transmitter as claimed in claim 9 wherein a transmitter driver circuit drives one coil in phase and a second coil via a switch network either in phase or in anti-phase.

11. An inductive power transmitter as claimed in claim 9 wherein a transmitter driver circuit drives a pair of coils via a full bridge so that the coils are driven in series when driven in phase and in parallel when driven in anti-phase.

12. An inductive power transmitter as claimed in any one of claims 9 to 11 wherein the transmitter coils are in a DD coil configuration.

13. An inductive power transmitter as claimed in any one of claims 9 to 12 including a backscatter communication receiver.

14. An inductive power transmitter as claimed in claim 13 wherein the backscatter communication receiver is adapted to extract receiver coil type information contained in a configuration packet.

15. An inductive power transmitter as claimed in claim 14 wherein the receiver coil type information is a single bit.

16. An inductive power transmitter, comprising:
a. a power transmitting coil;
b. a controller configured to receive communications signal from an inductive power receiver including information as to a power receiver coil type in order to control operation of the power transmitting coil.

17. An inductive power transmitter as claimed in claim 16 wherein the controller is adapted to re-configure operation of the power transmitting coils dependent upon the information as to a power receiver coil type.

18. An inductive power transmitter as claimed in claim 16 configured to drive a plurality of power transmitting coils in one of a plurality of modes depending on the power receiver coil type information contained in the signal.

19. An inductive power transmitter as claimed in claim 17 or 18 including a transmitter coil drive circuit which changes the transmitter coil drive topology in dependence upon the information as to power receiver coil type.

20. An inductive power transmitter as claimed in claim 19 wherein in a first mode the transmitter coil drive circuit is configured to apply a drive signal of a first polarity to one coil and a drive signal of a second polarity to another coil and in a second mode to provide a drive signal of the same polarity to both transmitter coils.

21. An inductive power transmitter as claimed in claim 20 wherein the transmitter coil drive circuit drives one coil in phase and a second coil via a switch network either in phase or in anti-phase.

22. An inductive power transmitter as claimed in claim 20 wherein the transmitter coil drive circuit drives a pair of coils via a full bridge so that the coils are driven in series when driven in phase and in parallel when driven in anti-phase.

23. An inductive power transmitter as claimed in any one of claims 16 to 22 wherein the transmitter coils are in a DD coil configuration.

24. An inductive power transmitter as claimed in any one of claims 16 to 23 including a backscatter communication receiver.

25. An inductive power transmitter as claimed in claim 24 wherein the backscatter communication receiver is adapted to extract receiver coil type information contained in a configuration packet.

26. An inductive power transmitter as claimed in claim 25 wherein the receiver coil type information is a single bit.

27. An inductive power transmitter, comprising:
a. a pair of transmitter coils in a DD coil configuration;
b. a controller configured to receive a communications signal from an inductive power receiver including information as to a power receiver coil type and drive the transmitter coils in phase or in anti-phase in dependence upon the information as to coil type.

28. An inductive power transmitter as claimed in claim 27 wherein the transmitter coils are driven in anti-phase when the receiver coil type is DDQ.

29. An inductive power transmitter, comprising:
a. a power transmitting coil; and
b. a controller which drives the power transmitting coil and is configured to change its mode of driving the transmitter coil in dependence upon receiver coil type.

30. An inductive power transmitter as claimed in claim 29 including a plurality of power transmitting coils wherein the controller is configured to change its mode of driving the transmitter coils in dependence upon receiver coil type.

31. An inductive power transmitter as claimed in claim 30 wherein the controller changes the configuration of a drive circuit driving the transmitter coils.

32. An inductive power transmitter as claimed in claim 31 wherein the drive circuit changes the coil configuration so that in a first mode a drive signal is applied to one end of a transmitter coil and in a second mode a drive signal is applied to an opposite end of that transmitter coil.

33. An inductive power receiver, comprising:
a. one or more power receiving coils;
b. a communications circuit for communicating with an inductive power transmitter, wherein the communications circuit is adapted to transmit information as to the receiver coil type.

34. An inductive power receiver as claimed in claim 33 including a backscatter communication circuit for modulating a signal applied by an inductive power transmitter to communicate coil type information.

35. An inductive power receiver as claimed in claim 33 or 34 wherein the coil type information is contained in a startup packet.

36. An inductive power receiver as claimed in claim 33 or 34 wherein the coil type information is contained in a configuration packet.

37. An inductive power receiver as claimed in claim any one of claims 33 to 36 wherein the coil type information indicates whether the coil type is DDQ or C.

38. An inductive power transfer system including:
a. an inductive power transmitter, comprising:
i. a power transmitting coil;
ii. a transmitter controller which drives the power transmitting coil in a plurality of modes; and
iii. a transmitter communications circuit for communicating with an inductive power receiver; and
b. an inductive power receiver, comprising:
i. a power receiving coil;
ii. a receiver controller which operates the power receiving coil in a plurality of modes; and
iii. a receiver communications circuit for communicating with the transmitter communications circuit,
wherein the transmitter controller and receiver controller communicate negotiate the modes of operation of the transmitter controller and receiver controller via the communications circuits.

39. An inductive power transfer system as claimed in claim 38 wherein the inductive power transmitter includes a plurality of power transmitting coils and the transmitter controller is adapted to drive the transmitter coils in a plurality of modes.

40. An inductive power transfer system as claimed in claim 38 or 39 wherein the inductive power transmitter includes a plurality of power receiving coils and the receiver controller is adapted to operate the receiver coils in a plurality of modes.
